(19) United States
(12) Patent Application Publication
(10) Pub. No.: US 2007/0280209 A1
(43) Pub. Date: Dec. 6, 2007

(54) COMBINING SELECTED AUDIO DATA WITH A VOIP STREAM FOR COMMUNICATION OVER A NETWORK

(75) Inventor: Ramkumar Ramani, Sunnyvale, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/422,041

(22) Filed: Jun. 2, 2006

(51) Int. Cl. H04L 12/66

(52) U.S. Cl. 370/356

(57) ABSTRACT

A system, method, and apparatus are directed towards combining playable data with other playable data and/or a Voice over Internet Protocol (VOIP) stream for communication over a network. A sender may select audio data through a customized user interface. The audio data may be converted to playable data. The playable data may be combined with the other playable data and/or the VOIP stream to generate a combined VOIP stream, for example, by utilizing digital audio mixing, or the like. The combined VOIP stream may be communicated over the network, to the at least one receiver. The at least one receiver of the VOIP stream may play the combined VOIP stream, thereby, enabling both the playable data and an original VOIP data to be played. Alternately, the sender may select to communicate the audio data out-of-band of the VOIP stream to the at least one receiver.

### FIELD OF THE INVENTION

The present invention relates generally to network communications, and more particularly, but not exclusively, to a system and method for combining selected audio data with a Voice over Internet Protocol (VOIP) stream for communication over a network.

### BACKGROUND OF THE INVENTION

IP Telephony, also known as Voice over Internet Protocol (VOIP), is a technology that makes it possible to have a voice conversation over a dedicated IP network, such as the Internet, instead of a dedicated voice transmission line.

Depending on the service, one way to place a VOIP call is to employ specialized phones, sometimes called IP Phones, or VOIP phones, that may look like a normal phone. Such VOIP phones may connect to the network through an RJ-45 connector, or operate through a wireless connection.

Because VOIP makes it possible to have voice conversations over IP networks, VOIP allows for a cost effective alternative to the traditional public switched telephone networks (PSTNs). Because of its relatively lower costs and ease of use, VOIP phone services have been rapidly increasing in popularity. With such an increase in popularity, there has been an increased desire to be able to integrate at least some of the VOIP features with a variety of other multimedia services. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be included in a system implementing the invention;

FIG. 3 illustrates one embodiment of a user interface for enabling a sender to communicate audio data and/or playable data to a recipient of a VOIP stream;

FIG. 4 illustrates a logical flow diagram generally showing one embodiment of a process for combining playable data with other playable data and/or a VOIP stream for communication over a network;

FIG. 5 illustrates a logical flow diagram generally showing another embodiment of a process for combining playable data with other playable data and/or a VOIP stream for communication over a network; and

FIG. 6 illustrates a data flow diagram generally showing one embodiment of a process for combining playable data with other playable data for communication over a network, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

As used herein, “a stream,” or “streaming,” refers to a continuous sequence of data. “Playable data” or “a playable format of audio data” refers to a streamed result of a conversion of data into a format suitable for output to an audio output device. As used herein, sending data “out-of-band” refers to sending data over a different network connection than a primary network connection, or sending the data distinct from a pre-defined path or packet.

Briefly stated, the present invention is directed towards a system, method, and apparatus for combining playable data with other playable data and/or a Voice over Internet Protocol (VOIP) stream for communication over a network. A sender may select audio data through a customized user interface. The audio data may be converted to the playable data. The playable data may be combined with the VOIP stream, for example, by utilizing digital audio mixing, or the like. In another embodiment, the playable data and the other playable data may be combined, and the combined playable data may be packaged into the combined VOIP stream. In one embodiment, the combined VOIP stream may be post-processed, by adjusting a balance, a channel, or the like. The combined VOIP stream may be communicated over the network to the at least one receiver. The at least one receiver of the VOIP stream may play the combined VOIP stream, thereby, enabling both the playable data and an original VOIP data to be played. Alternately, the sender may select to communicate the audio data out-of-band of the VOIP stream to the at least one receiver, for example, over at least one of a File Transfer Protocol (FTP) connection, a Hyper Text Transfer Protocol (HTTP) connection, a peer-to-peer connection, or the like. If a de-selection of the audio data is detected, then the combining of the playable data and the VOIP stream is interrupted.

### Illustrative Operating Environment

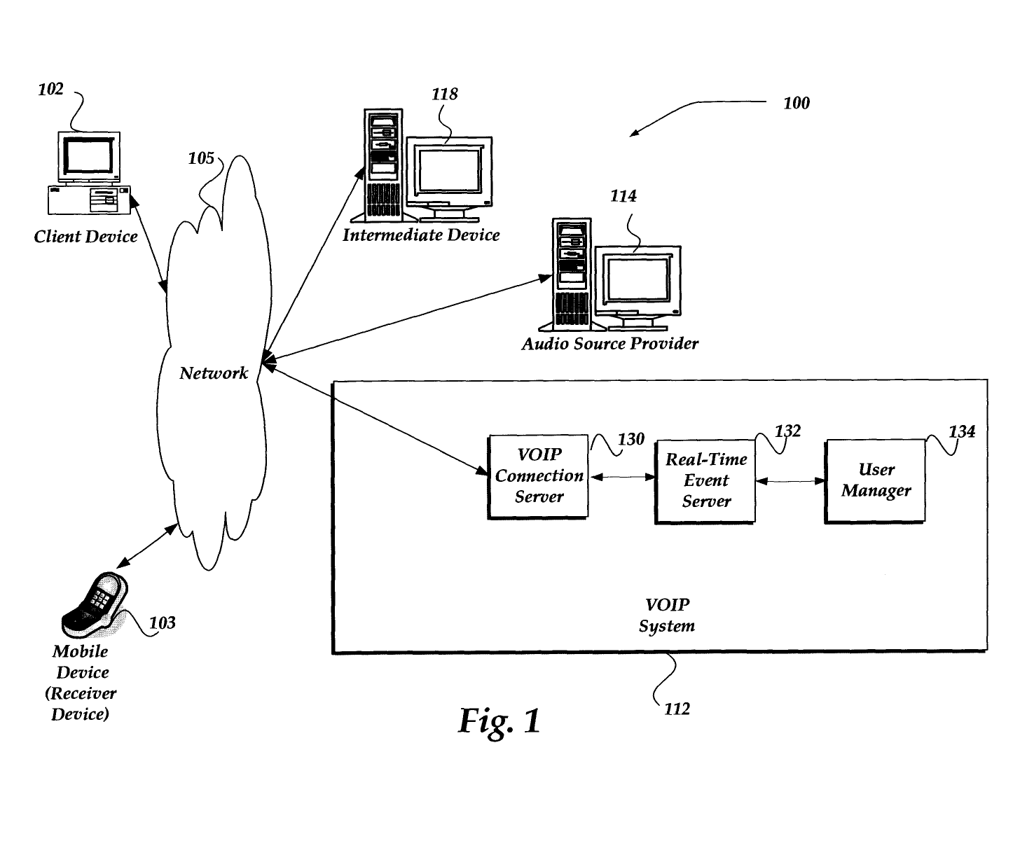

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client device 102, mobile device 103, network 105, audio service provider 114, intermediate device 118, and VOIP system 112. In one embodiment, VOIP system 112 includes VOIP connection server 130, Real-time event server 132, or user manager 134.

Client device 102 is in communication with VOIP system 112, intermediate device 118, and audio source provider 114, through network 105. Intermediate device 118 is in communication with client device 102, audio source provider 114 and VOIP system 112, through network 105. Mobile device 103 is in communication with VOIP connection server 130 through network 105. Real-time event server 132 is in communication with VOIP connection server 130, and user manager 134.

Audio Source provider 114 may include virtually any device that is arranged to send and receive media communications, including audio communications, multimedia communications, or the like. In one embodiment, audio source provider 114 may be a streaming audio data service. Audio source provider 114 may receive a request for audio data from client device 102, through a web interface, an XML-RPC interface, or the like. In one embodiment, the audio data may include media data. In one embodiment, audio source provider 114 may enable client device 102 to select audio data for download and/or streaming to client device 102 for further playing on client device 102. Audio source provider 114 may also perform digital rights management based on rights associated with client device 102 and/or a user (e.g. a sender) of client device 102, and may grant or deny access to the media data based, in part, on the rights.

Mobile device 103 may include virtually any device that is arranged to send and receive media communications and messages such as VOIP messages via one or more wired and/or wireless communication interfaces. For example, mobile device 103 may be configured to send and/or receive audio data between client device 102.

Typically, mobile device 103 may be configured to communicate using any of a variety of protocols. For example, mobile device 103 may be configured to employ RTP for communicating media data such as audio and video to another device. However, the invention is not so limited, and another media data mechanism may be employed, including IAX, and the like. Mobile device 103 may also employ the SIP protocol for enabling setting up a session and enabling such actions as dialing a number, enabling a ring, a ring-back tone, busy signal, and the like. However, other signaling protocols may also be employed, including H.323, Skinny Client Control Protocol (SCCP), IAX, MiNET, and the like. Typically, however, mobile device 103 may employ SIP over either UDP or TCP and RTP over UDP.

Mobile device 103 may also be configured to provide an identifier, sometimes known as an originating line identifier (OLI) during a communication. The identifier may employ any of a variety of mechanisms, including a device model number, a carrier identifier, a mobile identification number (MIN), and the like. The MIN may be a telephone number, a Mobile Subscriber Integrated Services Digital Network (MS-ISDN), an electronic serial number (ESN), or other device identifier. The OLI may also be an IP address associated with Mobile device 103. In one embodiment, the identifier is provided with each communication. In another embodiment, the identifier is provided by an end-user.

Devices that may operate as mobile device 103 include personal laptop computers, portable communication's devices, smart phones, Personal Digital Assistants (PDAs), handheld computers, programmable consumer electronics, standard telephones configured with an analog telephone adaptor (ATA), an IP phone, a Public Switched Telephone Network (PSTN) receiver, and the like.

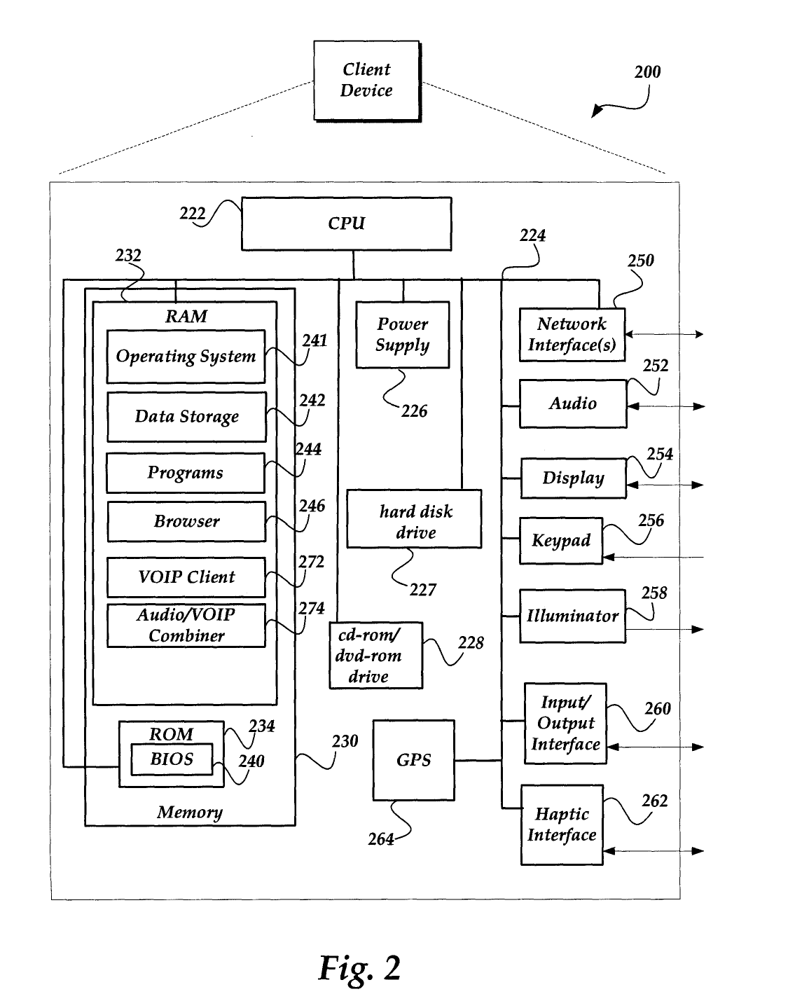

One embodiment of client device 102 is described in more detail below in conjunction with FIG. 2. Briefly, however, client device 102 may include virtually any computing device capable of receiving and sending a message over a network. The set of such devices may include devices that typically connect using a wired communications medium such as personal computers, desktop computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client device 102 may be any device that is capable of connecting using a wired or wireless communication medium such as a PDA, POCKET PC, wearable computer, and any other device that is equipped to communicate over a wired and/or wireless communication medium.

Client device 102 may be configured to employ VOIP connection server 130 to establish a communications, such as an audio communications with mobile device 103. Client device 102 may be configured to request a communication session between itself and another device. In one embodiment, client device 102 may select an initial CODEC, sampling frequency, bandwidth, compression complexity, or the like, for use in the communication session. In one embodiment, a VOIP stream may be communicated within the communication session.

In one embodiment, client device 102 may enable a sender to select audio data for providing over the VOIP stream. In one embodiment, client device 102 may receive the audio data from a local data source, or a remote data source, such as audio source provider 114 or the like. Client device 102 may convert the audio data into playable data. The playable data may be combined with the VOIP stream, for example, by utilizing digital audio mixing, or the like. The combined VOIP stream may be communicated over network 105, to at least one receiver, such as to mobile device 103. In one embodiment, client device 102 may send the combined VOIP stream over network 105 to VOIP system 112 for further processing and communication with at least one receiver that operates substantially similar to client device 102, or the like. In one embodiment, a uni-cast of the VOIP stream is directed to one receiver. In another embodiment, a multi-cast of the VOIP stream is directed to a plurality of receivers. In one embodiment, the audio data may be communicated out-of-band of the VOIP stream to the at least one receiver. In one embodiment, the audio data is communicated in its original format out-of-band.

It should be noted that mobile device 103 may also be enabled to combine playable data with other playable data and/or a VOIP stream for communication over a network. Therefore, the communication of a combined VOIP stream may be multi-directional between client device 102, mobile device 103, and/or or other devices.

Additionally, the combining of the playable data and the VOIP stream may also be performed by the another computing device associated with the communication session, including intermediate device 118, or the like, without departing from the scope or spirit of the invention.

Intermediate device 118 may include virtually any device that is arranged to send and receive and/or forward media communications and messages such as VOIP messages and/or audio data over a network. Intermediate device 118 may receive the VOIP stream from client device 102, and the audio data from client device 102, audio source provider 114, and/or another device. The intermediate device may further process the audio data to produce playable data, combine the playable data with VOIP data (e.g. packetized voice data) that is included within the VOIP stream and forward the combined VOIP stream over network 105 to VOIP system 112 for further processing and communication with the at least one receiver.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 may include any communication method by which information may travel between computing devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

VOIP system 112 is configured to manage VOIP streams, and other real-time communications between client devices using any of a variety of VOIP protocols, including a Session Initial Protocol (SIP), a Real-time Transport Protocol (RTP), H.323, Skinny Client Control Protocol (SCCP), IAX, MiNET, or the like. VOIP system 112 is further configured to enable a variety of client devices and client applications to access voice mail messages. Thus, VOIP system 112 may also be configured to enable a real-time message to be communicated as an audio message, voice message, graphics message, streaming message, or the like.

As shown, VOIP system 112 may be implemented in a single computing device, with each of the illustrated components operating as one or more processes with the single computing device. VOIP system 112 may also be implemented across multiple computing devices, with one or more of the illustrated components distributed across the multiple computing devices. As such VOIP system 112 may be implemented on a variety of computing devices including personal computers, desktop computers, multiprocessor systems, microprocessor-based devices, network PCs, servers, network appliances, and the like. In one embodiment, VOIP system 112 may include different and/or other components enabled to manage a VOIP stream between clients.

As shown, VOIP connection server 130 is configured to receive a request to establish a VOIP connection from client device 102, mobile device 103, and the like. In one embodiment, VOIP connection server 130 may enable a SIP connection. In one embodiment, the VOIP stream may be communicated over the VOIP connection and/or VOIP session. In one embodiment, the VOIP connection may be associated with a communication session.

The requesting device may provide identification information to VOIP connection server 130 that may be used, at least in part, to authenticate the request to establish the VOIP connection. If the requesting device is authenticated, VOIP connection server 130 may enable the requesting device to log into a connection. VOIP connection server 130 may also provide information about the requesting device to real-time event server 132. Real-time event server 132 may be configured to receive the information and provide it to user manager 134 for storage.

User manager 134 may store the information in a database, spreadsheet, table, file, and the like. Such information may include, for example, an identifier associated with the requesting device, an end-user associated with the requesting device, an address associated with VOIP connection server 130, and the like. User manager 134 may receive and manage such information for a plurality of requesting device. User manager 134 may also provide information to real-time event server 132 about at least one other requesting device, such that VOIP connection server 130 may enable a VOIP communication between one or more end-user devices.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 252 is arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as CD-ROM/DVD-ROM drive 228 and hard disk drive 227. Hard disk drive 227 is utilized by client device 200 to store, among other things, application programs, databases, and the like. Additionally, CD-ROM/DVD-ROM drive 228 and hard disk drive 227 may store audio data, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 is arranged to provide tactile feedback to a user (e.g. a sender) of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

In one embodiment, operating system 241 may include specialized digital audio mixing, analog audio mixing, and/or audio playing software. Operating system 241 may provide this software through functional interfaces, APIs, or the like. In one embodiment, digital audio mixing may include generating a new playable data that is based on a plurality of playable data input, where the new data may represent a superposition of the audio signals associated with the plurality of playable data input. Digital audio mixing may be enabled by operating system 241 through an API, such as Windows Driver Media (WDM) mixing APIs and/or digital mixing software libraries, such as Windows' DirectSound, FMOD, Miles Sound System, Open Sound System (OSS), SDL Mixer, CAM (CPU's audio mixer), or the like. In one embodiment, stereophonic (stereo) audio data may be converted into mono-audio data to be played over a mono-audio device, or the like. Similarly, analog audio mixing may be enabled by APIs to convert digital data into an analog signal (e.g. modulation), add and/or filter several analog signals, and re-convert the analog signal into digital data. In one embodiment, the addition and/or filtering may be performed by a summing amplifier.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

In one embodiment, programs 244 may include specialized audio mixing and/or playing software. Programs 244 may provide this software through functional interfaces, APIs, or the like. Programs 244 may also include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, CODEC programs, and so forth. In addition, mass memory 230 stores browser 246, VOIP client 272, and audio/VOIP combiner 274.

In addition to being stored in programs 244, CODECs may be stored in data storage 242, or the like. CODECS may be made available to other components, such as VOIP client 272, Audio/VOIP combiner 274, through an API, or the like. Examples of CODECs for general audio files include Audio Interchange File Format (AIFF), Resource Interchange File Format (RIFF), Microsoft “wave” format (WAV), Apple Lossless Format, Audio Lossless Coding (MPEG-4 ALS), Direct Stream Transfer (DST), Free Lossless Audio CODEC (FLAC), RealAudio Loseless, Windows Media Audio 9 Lossless, Advanced Audio Coding (AAC) (e.g., MPEG-2 and MPEG-4), Dolby Digital (A/52, AC3), MPEG audio layer-1 (MP1), MPEG audio layer-2 (MP2) Layer 2 audio CODEC (e.g., MPEG-1, MPEG-2 and non-ISO MPEG-2.5), MPEG audio layer-3 (MP3) Layer 3 audio CODEC, Windows Media Audio (WMA), or the like. Examples of CODECs for voice files include Adaptive Multi-Rate (AMR), Code Excited Linear Prediction (CELP), Digital Speech Standard (DSS), G.7X, Global System for Mobile Communication (GSM) CODECs, Selectable Mode Vocoder (SMV), or the like. Some voice CODECs may support a low bit rate, while others, such as wideband CODECs may enable higher bit rates and thus, better audio quality. For example, a wideband CODEC may be able to support up to 8 KHz.

Browser 246 may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

VOIP client 272 is configured to enable client device 200 to initiate and manage a VOIP session with another client device. VOIP client 272 may employ the SIP protocol for managing signaling, and RTP for transmitting VOIP traffic. However, the invention is not so constrained, and any of a variety of other VOIP protocols may be employed including IAX which carries both signaling and voice data, H.323, SCCP, Megaco, MGCP, MiNET, Skinny Client Control Protocol (SCCP), and the like. VOIP client 272 is further configured to employ virtually any CODEC to compress the data for communicating it over the network, including G.711, G.729, G.729a, iSAC, Speex, and the like. In one embodiment, a wideband CODEC may be utilized to support a high bandwidth audio stream.

Audio/VOIP combiner 274 is configured to receive audio data, from, for example, a hardware device, data generated from software, or even files. For example, the audio data may be received from audio interface 252, CD-ROM/DVD-ROM 228, hard disk drive 227, from another computing device over network interface(s) 250, played or the like. Other audio data from hardware may include microphone input, line input, CD audio, FM synthesizer input, Wavetable synthesizer input, phone input, or the like. Audio data from hardware may also include wave playback, Microsoft DirectSound data, software synthesized data, or the like. Audio data may be in a variety of formats, including Advanced System Format (ASF), Audio Video Interleave (AVI), MP3, QuickTime, RealMedia, WMA, WAV, a proprietary format, or the like. Audio data may, in some cases be associated with a particular CODEC for decoding/encoding the particular format of the audio data.

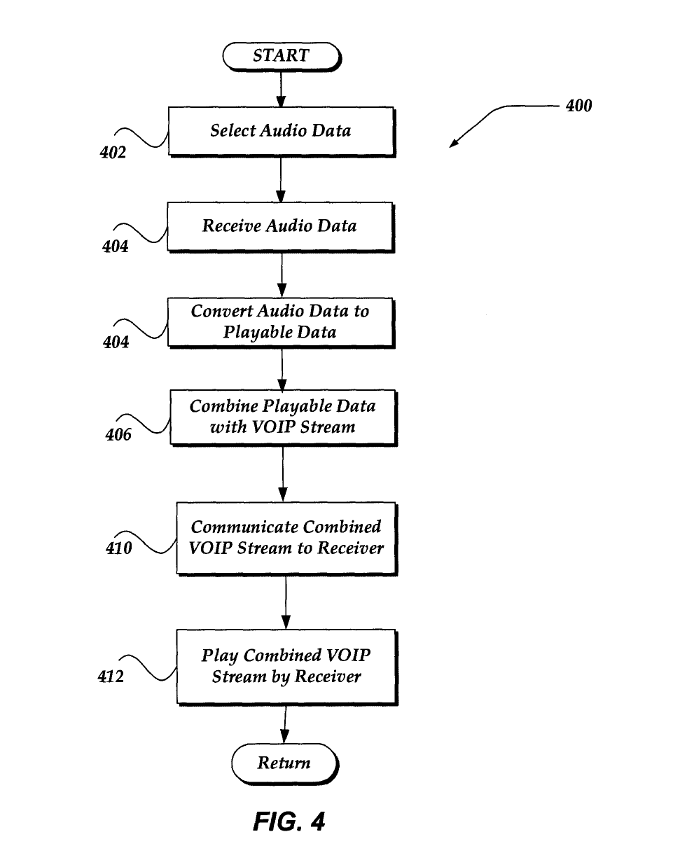

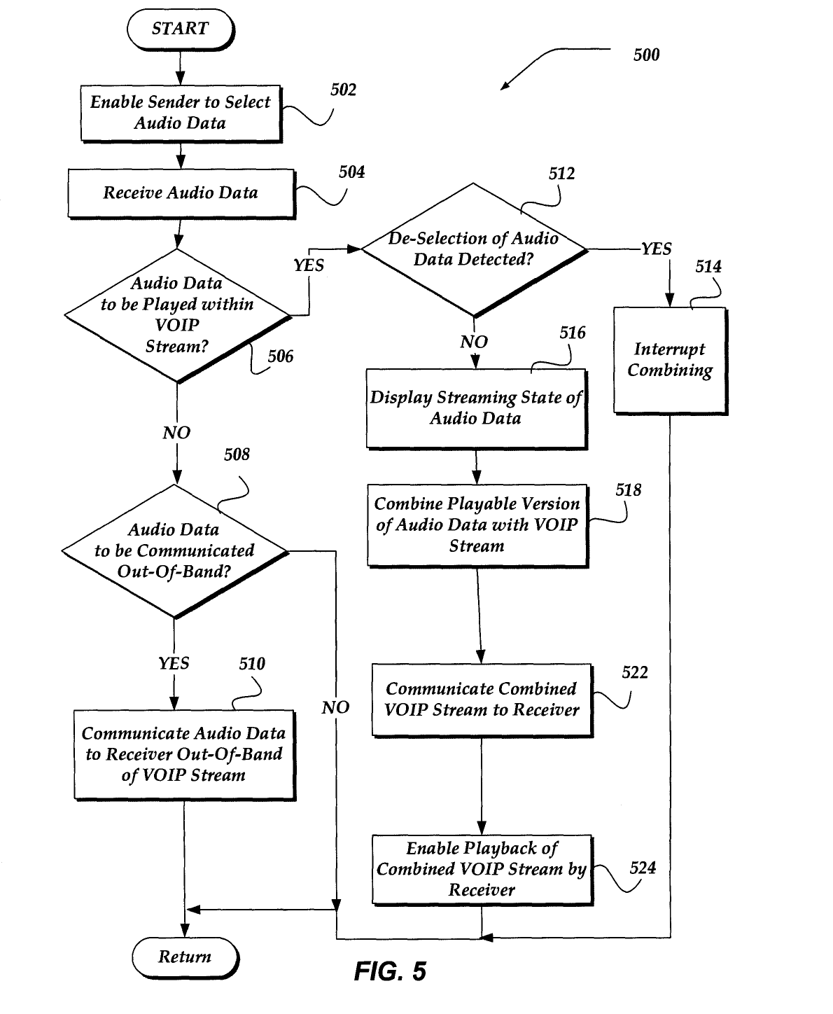

Audio/VOIP combiner 274 may enable playing of the audio data by invoking an API of operating system 241, a library, or the like. For example, Audio/VOIP combiner 274 may convert the audio data into playable data suitable for output to audio interface 252, or the like. In some embodiments, a VOIP connection and/or a VOIP stream may support mono-audio, and thus, a stereophonic audio data may be converted to mono-audio. Audio/VOIP combiner 274 may further inspect a VOIP stream managed by VOIP client 272. Audio/VOIP combiner 274 may combine a playable format of the audio data (e.g. playable data) with other playable data and/or a VOIP data within the VOIP stream by invoking, for example, a digital audio mixing API, or the like. In one embodiment, audio/VOIP combiner 274 may communicate the audio data out-of-band of the VOIP stream to at least one receiver though network interface(s) 250. Audio/VOIP combiner 274 may employ at least a portion of processes such as described below in conjunction with FIGS. 4-5 to perform at least some of its actions.

Although not shown, client device 200 may also be configured to receive a message from another computing device, employing another mechanism, including, but not limited to email, Short Message Service (SMS), Multimedia Message Service (MMS), internet relay chat (IRC), mIRC, and the like.

### Illustrative User Interface

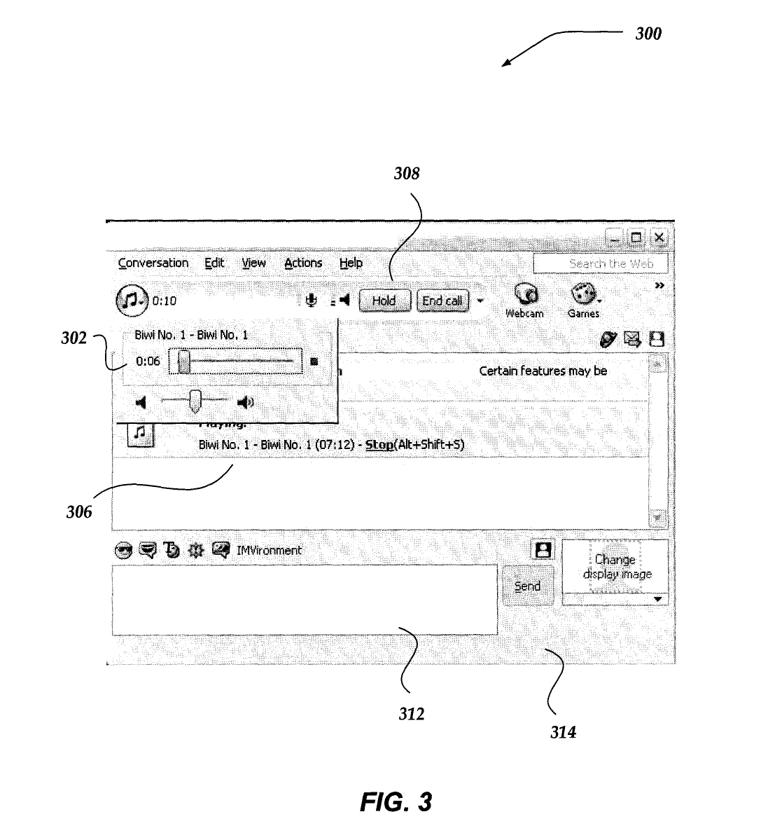

FIG. 3 illustrates one embodiment of a user interface for enabling a sender to communicate audio data and/or playable data to a recipient of a VOIP stream. This user interface is not to be considered as limiting the invention, but rather is provided as but one possible implementation of a mechanism for providing status and/or an input mechanism for selecting various options associated with playing and/or communicating playable data with a VOIP stream. In one embodiment, display 300 of FIG. 3 may be outputted to a screen of a device, such as client device 200 of FIG. 2.

Display 300 may employ an Instant Message (IM) client interface. As shown, display 300 includes automated connection selection (ACS) 308, control of an audio source (CAS) 302, meta-data of an audio source (MAS) 306, text input 312, and panel area 314. Display 300 may also include a window (not shown), the window providing a set of audio data entries, wherein least one of the audio data entries may be selected, through a selection from a user interface selection device, or the like.

ACS 308 may include an icon, button, or the like, that, when selected, automatically enables VOIP connection and/or VOIP session to be established. In one embodiment, a VOIP stream may be communicated over the enabled VOIP connection and/or VOIP session. In another embodiment, ACS 308 may enable a VOIP stream to be communicated directly without the use of a VOIP session. In one embodiment, text input 312 receives text input and enables sending the text input to an IM receiver. In one embodiment, the IM receiver is also the receiver of the VOIP stream. In another embodiment, display 300 may enable a conference call, which allows communication to a plurality of receivers.

In one embodiment, display 300 may enable communicating a playable format of the audio data (e.g. playable data) and/or the audio data to at least one receiver. In one embodiment, display 300 may be employed during process 400 of FIG. 4 and/or process 500 of FIG. 5 described below.

In one embodiment, if a user (e.g. sender) of display 300 indicates that the audio data is to be provided with the VOIP stream, a playable format of the audio data (e.g. playable data) is combined with the VOIP stream for communication to the at least one receiver. In one embodiment, the indication may be the user dragging an identifier of audio data (e.g. an icon or a text label), and dropping the identifier onto an area of display 300 associated with the VOIP stream. Such area may include ACS 308, CAS 302, MAS 306, or the like. In one embodiment, the indication may be received from keypad 256, input/output interface 260 of FIG. 2, or the like. Other user interface operations, besides dragging-and-dropping, may also be used as the indication. For example, the user may select the audio data for playing from a check list, a drop down box, or the like.

In one embodiment, if the user indicates that the audio data is to be communicated out-of-band, the audio data is communicated out-of-band of the VOIP stream to the at least one receiver. In one embodiment, the indication may be the user dragging an identifier of the audio data, and dropping the identifier onto an area of display 300 not associated with the VOIP stream, such as text input 312, panel area 314, or the like. In one embodiment, the indication may be received from keypad 256, input/output interface 260 of FIG. 2, or the like. Other user interface operations, besides dragging-and-dropping, may also be used as the indication. For example, the user may select the audio data for communicating out-of-band from a check list, a drop down box, or the like.

In one embodiment, a state of audio data may be displayed in CAS 302. The state of the audio data may be at least one of a play state (e.g. a state of the playable format of the audio data), a track position, a track time, an indication of the selection of the audio data within a play list, meta-data about the audio data, or the like. In one embodiment, CAS 302 may enable a de-selection of the audio data, through a stop button, pause button, close button on CAS 302 and/or MAS 306, an error condition, or the like. In one embodiment, the de-selection may be the user ending the VOIP call by selecting an end-call button from ACS 398, or the like. If de-selection of the audio data is detected, then combining the playable data with the VOIP stream may be interrupted. In one embodiment, meta-data of the audio data may also be displayed in MAS 306. Meta-data of the audio data may include a song title, album title, artist name, lyrics, record label, date of creation, comments, ranking scores, or the like.

### Generalized Operation

The operation of certain aspects of the invention will now be described with respect to FIGS. 4-5. FIG. 4 illustrates a logical flow diagram generally showing one embodiment of a process for combining playable data with other playable data and/or a VOIP stream for communication over a network. Process 400 of FIG. 4 may, for example, be performed within client device 102, mobile device 103, or even intermediate device 118 of FIG. 1.

Process 400 begins, after a start block, at block 402, where a sender of a VOIP stream is enabled to select audio data. In one embodiment, the sender is enabled to select the audio data from a remote source or a local source. In one embodiment, the sender is enabled to select the audio data from a play-list. In one embodiment, a sender may send a request for the audio data to a remote source, such as audio service provider 114 of FIGURE, and may receive the audio data based on the request. In one embodiment, digital rights management may be applied to an access of the audio data, either by inhibiting the playing of the audio data based on a digital right of the sender, inhibiting the sending of data source to the sender, or the like. In one embodiment, the audio data may include at least one of a Waveform audio format (WAV) file, a Musical Instrument Digital Interface (MIDI) file, or a Moving Picture Experts Group (MPEG) Audio Layer 3 (MP3) file, or the like.

Processing next continues to block 404, where the audio data is received. In one embodiment, the audio data may be received from a local store, (e.g., RAM, ROM, hard disk drive, CD-ROM, DVD-ROM), a remote store (e.g. over a network), or the like. In one embodiment, the received audio data may be received from at least one of an email, a streaming media data from a server, or a search result list, or the like. Processing continues next to block 405.

At block 405, the audio data is converted into playable data. The conversion may include COmpression/DECompression (CODEC) decoding, a lossy or lossless decompressing, a decrypting, an isolation of audio data from a multimedia source, an adjusting of a characteristic such as the pitch, tone, timbre, volume, or harmonic distortions of the audio data, or the like. In one embodiment, it may be determined that the audio data is already in a substantially playable format. In that instance, the process of conversion may include recognizing the format of the audio data. Processing continues next to block 406.

At block 406 the playable data is combined with the VOIP stream. In one embodiment, block 405 and 406 may occur concurrently. In one embodiment, all or completely all of the audio data may be converted to the playable data before being combined. In another embodiment, at least a portion of the audio data may be converted to playable data and then combined with the VOIP stream. In one embodiment, a VOIP data may be extracted from the VOIP stream. The VOIP data may be in the form of a network packet, or the like. The VOIP data may include voice data, or the like. In one embodiment, the VOIP data may be converted into other playable data for combining with the playable data. The VOIP data may be combined with the playable data, using for example, digital and/or audio mixing. In one embodiment, combining the playable data with the VOIP stream further comprises at least digital audio mixing, analog audio mixing, or the like. In one embodiment, combining the playable data with the VOIP stream further comprises combining a portion of the playable data (e.g. a clip) with a portion of the VOIP stream. In one embodiment, combining the playable data with the VOIP stream further comprises encoding the combined VOIP stream with a wideband CODEC. In one embodiment, combining further comprises post-processing of the playable data and the VOIP data within the VOIP stream (e.g. post-processing the combined VOIP stream). In one embodiment, post-processing of the combined VOIP stream comprises adjusting the balance between a channel of the playable data and a channel of the VOIP stream, wherein the channels are at least one of pitch, tone, timbre, volume, or the like.

In one embodiment, the playable data may be played while being converted, combined and/or adjusted during blocks 405 and/or 406. In another embodiment, the audio data may be converted completely to playable data before being played. In another embodiment, a portion of audio data may be converted before being played. In still another embodiment, the combined VOIP data (e.g. the combination of the playable data and the data within the VOIP stream) may be played. In one embodiment, the playable data and/or the combined VOIP data may be played over an audio output device on the same device which combines the playable data with the VOIP stream (e.g. local playing). In one embodiment, this local playing provides feedback to the sender so that the sender may adjust the characteristics and/or the balance of the playable data, select other playable data, or the like. Processing continues next to block 410.

At block 410, the combined VOIP stream is communicated to at least one receiver. In one embodiment, the at least one receiver is at least one of a Public Switched Telephone Network (PSTN) receiver, a mobile device, a client device, or the like. In one embodiment, the combined VOIP stream may be converted to a PSTN data (e.g. an analog signal) for transmission to a PSTN receiver device. In one embodiment, communicating the combined VOIP stream further comprises communicating meta-data about the audio data, the playable data, the combined VOIP stream, or the like, over the network to the at least one receiver of the VOIP stream. In one embodiment, the meta-data may be sent to the at least one receiver out-of-band of the VOIP stream. In one embodiment, the meta-data may be streamed along with the VOIP stream. For example, a particular portion of a lyric associated with a portion of a song that is being played may be streamed. In one embodiment, communicating the combined VOIP stream comprises at least one of uni-casting the VOIP stream, multi-casting the combined VOIP stream, or the like. Processing continues next to block 412.

At block 412, the at least one receiver is enabled to play the combined VOIP stream. In one embodiment, the at least one receiver may decode the VOIP stream, and send the decoded data to an audio output device, or the like. In one embodiment, the played output may be in mono-digital audio. Process 400 then returns to a calling process to perform other actions.

In an alternate embodiment (not shown), at block 406, the playable data may be combined with other playable data. In one embodiment, the other playable data might not be included within the VOIP stream. The other playable data may be received from another source, including, for example, an audio input device, a file, over the network, or the like. The playable data and the other playable data may be combined in a manner substantially similar to the process described at block 406 above. In one embodiment, the combined playable data may be packaged into the combined VOIP stream. Processing then continues to block 410.

In an alternate embodiment (not shown), after block 406, the combined VOIP stream may be combined with at least other playable data (e.g. another playable format of other audio data). The other audio data may be selected by the sender, received from another device, predefined by settings, or the like. Processing then continues to block 410 for further processing.

FIG. 5 illustrates a logical flow diagram generally showing another embodiment of a process for combining playable data with other playable data and/or a VOIP stream for communication over a network. Process 500 of FIG. 5 may, for example, be performed within client device 102, mobile device 103, or even intermediate device 118 of FIG. 1.

Process 500 begins, after a start block, at block 502, where a sender of a VOIP stream is enabled to select audio data. Block 502 is substantially similar to block 402 of FIG. 4. Processing next continues to block 504, where the selected audio data is received. Block 504 is substantially similar to block 404 of FIG. 4. Processing next continues to decision block 506.

At decision block 506, if it is determined that the audio data is to be provided with the VOIP stream, then processing continues to decision block 512. In one embodiment, the determination is based on an indication from a user interface, such as user interface 300 of FIG. 3. For example, if the sender drops an identifier (e.g. an icon) associated with the audio data onto an area associated with the VOIP stream, processing continues to block 512. If it is determined that the audio data is not to be provided with the VOIP stream, then processing continues to decision block 508.

At decision block 508, if it is determined that the audio data is to be communicated out-of-band of the VOIP stream, then processing continues to block 510. In one embodiment, the determination is based on an indication from a user interface, such as user interface 300 of FIG. 3. If it is determined that the audio data is not to be uploaded, processing returns to a calling process to perform other actions.

At decision block 512, if a de-selection of the audio data is detected, processing continues to block 514, where the combining of a playable format of the audio data (e.g. playable data) with the VOIP stream is interrupted, and processing returns to a calling process for other actions. Otherwise, processing continues to block 516. In one embodiment, the de-selection may include at least one of a user input, the VOIP stream pausing, the VOIP stream ending, an ending of the playing of the playable data, a detection of an error within the playable data, or the like. In an alternate embodiment, decision block 512 may operate in parallel with blocks 516, 518, 522, or 524. For example, processing may detect a de-selection of the audio data throughout the process of combining playable data with the VOIP stream and communicating the combined VOIP stream.

At block 516, a state of the audio data is displayed. In one embodiment, the state of the audio data may include at least one of a play state, a track position, a track time, an indication of the selection of the audio data within a play list, meta-data about the audio data, or the like. In one embodiment, block 516 may occur concurrently with any block within FIG. 5. Processing next continues to block 518.

At block 518, playable data are combined with a VOIP stream. Block 518 is substantially similar to block 406 of FIG. 4. Processing next continues to block 522, where the combined VOIP stream is communicated to at least one receiver. Block 522 is substantially similar to block 410 of FIG. 4. Processing next continues to block 524, where the at least one receiver is enabled to play the combined VOIP stream. Block 524 is substantially similar to block 412 of FIG. 4. Processing then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

### Illustrative Data-Flow Diagram

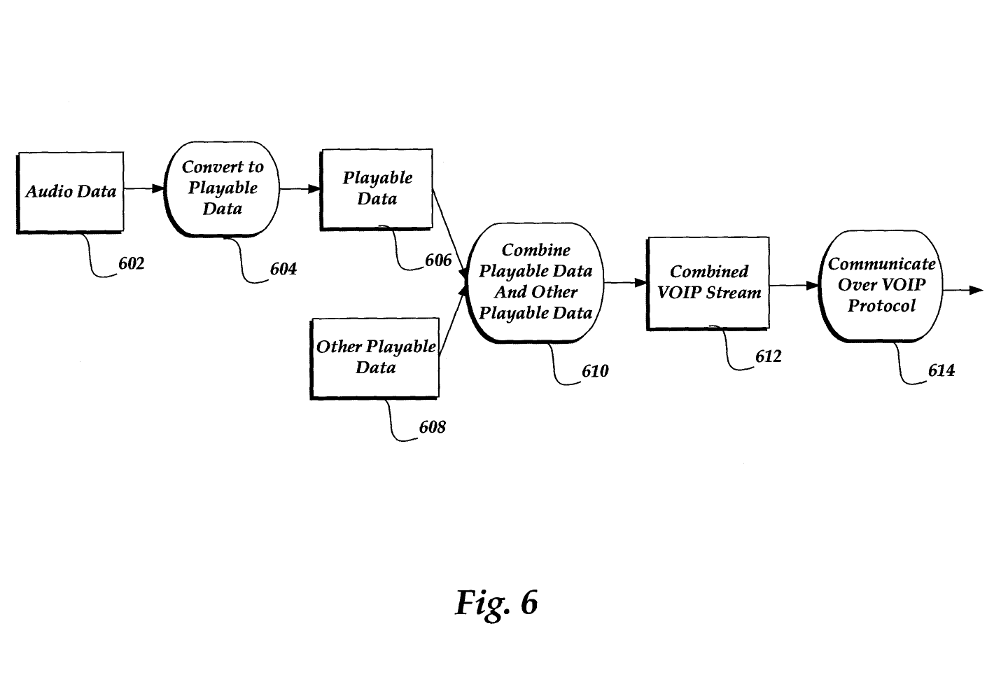

FIG. 6 illustrates a data flow diagram generally showing one embodiment of a process for combining playable data with other playable data for communication over a network. At time-point 602, audio data is received. At time-point 604, the audio data is converted to playable data, through for example, CODEC-decoding, decompression, or the like, as described above in conjunction with block 404 of FIG. 4. A time-point 606, the playable data is realized.

At time-point 608, other playable data is received. Time-point 608 may occur any time before or concurrently with time-point 610. The other playable data may be received from an audio input device, a file, over a network, or the like. In one embodiment, VOIP data (e.g. packetized voice data) may be extracted from a VOIP stream. In one embodiment, the VOIP stream may be received from a plurality of senders, such as over a VOIP conference call, or the like. The VOIP data may be converted to the other playable data. In one embodiment, the VOIP data may already be in a playable format and may be combined in its original format.

At time-point 610, the playable data and the other playable data are combined to generate a combined playable data, as described above in conjunction with block 406 of FIG. 4. The combined playable data may be packaged into a combined VOIP stream. In one embodiment, the data may be compressed, encoded (e.g. with a CODEC), encrypted, and/or packetized for transport within the combined VOIP stream. At time-point 612, the combined VOIP stream is realized. At time-point 614, the combined VOIP stream is communicated to at least one receiver utilizing any VOIP protocol, including H.323, Skinny Client Control Protocol (SCCP), IAX, MiNET, and the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for communicating audio data over a network, comprising:
converting the audio data into playable data;
combining the playable data with a VOIP stream;
communicating the combined VOIP stream over the network; and
enabling a playing of the combined VOIP stream by at least one receiver.

2. The method of claim 1, further comprising:
if an input indicates that the audio data is to be communicated out-of-band, communicating the audio data out-of-band from the VOIP stream.

3. The method of claim 1, wherein communicating the combined VOIP stream further comprises at least one of uni-casting the combined VOIP stream, or multi-casting the combined VOIP stream over the network.

4. The method of claim 1, wherein converting the audio data into playable data further comprises employing a COmpression/DECompression (CODEC) to decode or to decompress the audio data.

5. The method of claim 1, wherein combining the playable data with a VOIP stream further comprises:
extracting data from the VOIP stream;
combing the extracted data with the playable data by digitally mixing the data; and
generating the combined VOIP stream by converting the digitally mixed data into VOIP data.

6. The method of claim 5, further comprising:
adjusting at least one characteristic of the playable data or the extracted data prior to combining the data, wherein the at least one characteristic further comprises at least one of the following: pitch, tone, timbre, or volume.

7. A modulated data signal configured to include program instructions for performing the method of claim 1.

8. The method of claim 1, further comprising playing at least a portion of the playable data over an audio output device, at least partly while performing the combining step.

9. A network device for communicating audio data over a network, comprising:
a transceiver for sending and receiving data;
a processing component arranged to perform actions, comprising:
combining at least a portion of a playable formatted data of the audio data with at least a portion of data within a VOIP stream;
formatting the combined data to a combined VOIP stream; and
sending the combined VOIP stream over the network.

10. The network device of claim 9, wherein combining further comprises at least digital audio mixing of data within the VOIP stream with the playable formatted data.

11. The network device of claim 9, wherein the audio data further comprises data from a plurality of audio data sources.

12. The network device of claim 9, wherein combining the playable format of the audio data with the VOIP stream further comprises modifying a balance between a channel of the playable format of the audio data and a channel of data within the VOIP stream.

13. The network device of claim 9, wherein sending the combined VOIP stream further comprises:
sending the combined VOIP stream to another device, wherein the other device is configured to convert the combined VOIP stream into Public Switched Telephone Network (PSTN) data.

14. The network device of claim 9, wherein the actions further comprise playing the at least the portion of the playable formatted data of the audio data at least partly while performing the combining action.

15. A system for communicating audio data over a network, comprising:
a receiver device operable to perform actions comprising:
receiving a combined Voice over Internet Protocol (VOIP) stream; and
enabling a playing of the combined VOIP stream; and
a client device operable to perform the actions comprising;
combining a playable format of the audio data with data within a VOIP stream to generate the combined VOIP stream; and
communicating the combined VOIP stream to the receiver device.

16. The system of claim 15, wherein the audio data is provided to the client device by a server.

17. The system of claim 15, wherein combining a playable format of the audio data with data within a VOIP stream further comprises:
extracting the data from the VOIP stream;
combing the extracted data with the playable data by audio mixing the data; and
generating the combined VOIP stream by converting the mixed data into VOIP data.

18. A computer processor readable medium for communicating audio data over a network, that includes instructions, wherein the execution of the instructions performs actions, comprising:
audio mixing a playable format of the audio data with data within a VOIP stream to generate a combined VOIP stream; and
communicating the combined VOIP stream over the network.

19. The computer processor readable medium of claim 18, wherein the audio data is at least one of a Waveform audio format (WAV) file, a Musical Instrument Digital Interface (MIDI) file, or a Moving Picture Experts Group (MPEG) Audio Layer 3 (MP3) file.

20. The computer processor readable medium of claim 18, wherein the audio data is received within at least one of an email message, streaming media data over the network, or a search result list.

21. A network device for communicating audio data over a network, comprising:
a transceiver for sending and receiving data;
means for selecting the audio data;
means for converting the audio data into playable data; and
means for combining the playable data with a VOIP stream to generate a combined VOIP stream.

22. The network device of claim 21, further comprising a means for communicating meta-data about the audio data over the network.

23. A computer system having a graphical user interface including a display, a user interface selection device, and a processor operable to perform actions comprising:
displaying a window on the display, the window providing a set of selectable audio data entries;
receiving a selection of at least one of the selectable audio data entries from the user interface selection device; and
if a user interface operation indicates an audio data associated with the selection is to be provided with a VOIP stream, combining a playable version of the audio data with the VOIP stream to generate a combined VOIP stream for communication over the network.

24. The computer system of claim 23, wherein the user interface operation is at least one of dropping an identifier associated with the selection onto an area of the display associated with communicating within the VOIP stream or onto another area of the display associated with communicating out-of-band of the VOIP stream.

25. The computer system of claim 23, wherein the actions further comprise displaying a state of the audio data.

26. The computer system of claim 23, wherein the actions further comprise if a de-selection of the audio data is detected, interrupting combining of the playable format of the audio data with the VOIP stream.

27. A method for communicating audio data over a network, comprising:
combining a playable format of the audio data with other playable data from an audio input device to generate a combined VOIP stream; and
communicating the combined VOIP stream over the network.

28. The method of claim 27, further comprising extracting the other playable from another VOIP stream for combining with the playable format of the audio data.

29. A method for communicating audio data over a network, comprising:
combining playable data with data from an audio input device to generate a combined playable data;
packaging the combined playable data into a VOIP stream; and
communicating the VOIP stream over the network.
